(19) United States
(12) Patent Application Publication
(10) Pub. No.: US 2006/0088766 A1
(43) Pub. Date: Apr. 27, 2006

(54) Negative active material for non-aqueous electrolyte battery, method of preparing same and non-aqueous electrolyte battery

(75) Inventors: Sung-Soo Kim, Suwon-si (KR); Yoshiaki Nitta, Suwon-si (KR); Nedoseykina Tatiana I., Yongin-si (KR); Jae-Cheol Lee, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/258,150

(22) Filed: Oct. 26, 2005

(30) Foreign Application Priority Data
Oct. 27, 2004 (KR) 10-2004-0086153

(51) Int. Cl. H01M 4/48; C01G 25/02; C01G 37/14; C01G 31/02; C01G 23/04; C01G 41/02; C01G 39/02

(52) U.S. Cl. 429/231.2; 429/231.5; 423/594.15; 423/594.8; 423/600; 423/594.12; 423/598; 423/596

(57) ABSTRACT

A negative active material includes a vanadium-based oxide to achieve outstanding safety and cycle life characteristics in a non-aqueous lithium secondary battery. A second metal is substituted for a small portion of the vanadium to improve the stability of the crystal lattice of the vanadium-based oxide and maintain the capacity of the negative active material. The negative active material has a free-edge energy peak between about 5350 eV to about 5530 eV measured by Extended X-ray Absorption Fine Structure.

### CROSS REFERENCE TO RELATED APPLICATION

This application claims priority to and the benefit of Korean Patent Application No. 10-2004-0086153 filed in the Korean Intellectual Property Office on Oct. 27, 2004, which is hereby incorporated by reference in its entirety for all purposes as if fully set forth herein.

### BACKGROUND OF THE INVENTION

1. Field of the Invention

The present invention relates to a negative active material for a non-aqueous electrolyte lithium secondary battery that has good safety and cycle life characteristics, a method of preparing the negative active material, and a lithium secondary battery that includes the negative active material.

2. Background of the Invention

Recently, there has been an increase in the use of lithium secondary batteries as a power source for electronic equipment, due to reductions in size and weight of portable electronic equipment and the need for batteries with a high energy density and a high power density. A lithium secondary battery using an organic electrolyte has been proven to have a high energy density and also has a discharge voltage more than twice as high as conventional batteries using an alkali aqueous solution as an electrolyte.

Oxides that include lithium and a transition metal that can intercalate lithium, such as LiCoO₂, LiMn₂O₄, and LiNi₁₋ₓCoxO₂ (0<x<1), have been used as a positive active material.

Various types of carbon-based materials, such as hard carbon and artificial and natural graphite have been used as a negative active material. These carbon-based materials can intercalate and deintercalate lithium ions. Graphite is the most comprehensively used material among the aforementioned carbon-based materials. Graphite guarantees a good cycle life for a battery due to its outstanding reversibility and advantageous energy density, because it has a low discharge voltage of −0.2V compared to lithium. Accordingly, a battery using graphite as a negative active material has a high discharge voltage of 3.6V.

But graphite active material has a low density (its theoretical density is 2.2 g/cc), and consequently a low capacity in terms of energy density per unit volume of an electrode. Also, graphite active material may explode or combust if a battery is misused or overcharged because graphite is likely to react to an organic electrolyte at a high discharge voltage.

Researchers have recently been studying an oxide negative electrode to overcome the shortcomings of graphite active material. Fuji Film, for example, developed an amorphous tin oxide. The amorphous tin oxide had a high capacity per weight (800 mAh/g), but resulted in some critical defects, including a high initial irreversible capacity of up to 50%, a high electric potential of over 0.5 V, and a smooth voltage profile, which is unique in the amorphous phase. Furthermore, some of the tin oxide tended to be reduced to tin during the charge or discharge reaction. These difficulties made amorphous tin oxide largely unacceptable for use in a battery.

Japanese Patent Publication No. 2002-216753 (SUMITOMO METAL IND LTD) discloses LiₐMg_{b}VO_{c}, where 0.05≦a≦3, 0.12≦b≦2, and 2≦2c-a-2b≦5, as another example of an oxide negative electrode. Yet another example of an oxide negative electrode was presented in the 2002 Japanese Battery Conference (Preview No. 3B05), which disclosed a lithium secondary battery that included Li_{1.1}V_{0.9}O₂ as the oxide negative electrode

Despite these past efforts, a need for a negative active material with improved safety and cycle life characteristics remains.

### SUMMARY OF THE INVENTION

This invention provides a negative active material that includes a vanadium-based oxide to achieve outstanding safety and cycle life characteristics in a non-aqueous lithium secondary battery. Another metal is substituted for a small portion of the vanadium to improve the stability of the crystal lattice of the vanadium-based oxide and maintain the capacity of the negative active material. The negative active material has a free-edge energy peak between about 5350 eV to about 5530 eV measured by Extended X-ray Absorption Fine Structure and has a higher capacity than a conventional graphite active material.

The present invention also provides a method for preparing a negative active material for use in a non-aqueous lithium secondary battery.

The present invention also provides a non-aqueous lithium secondary battery that includes the negative active material.

Additional features of the invention will be set forth in the description which follows, and in part will be apparent from the description, or may be learned by practice of the invention.

The present invention discloses a negative active material for use in a non-aqueous electrolyte secondary battery that includes a vanadium-based oxide represented by the equation:
LiₓM_{y}V_{z}O_{2+d}

where 0.1≦x≦2.5, 0≦y≦0.5, 0.5≦z≦1.5, 0≦d≦0.5, and M is selected from the group of Al, Cr, Mo, Ti, W and Zr.

The present invention also discloses a method of preparing a negative active material for use in a non-aqueous electrolyte secondary battery that includes mixing a vanadium-containing source, a lithium-containing source, and a metal-containing source in solid phase, and heating the mixture under a reducing atmosphere. The vanadium containing source, the lithium-containing source, and the metal-containing source are mixed in a ratio to produce a vanadium-based oxide represented by the equation:
LiₓM_{y}V_{z}O_{2+d}

where 0.1≦x≦2.5, 0≦y≦0.5, 0.5≦z≦1.5, 0≦d≦0.5, and M is selected from the group of Al, Cr, Mo, Ti, W and Zr.

The present invention also discloses a non-aqueous electrolyte lithium secondary battery that includes a non-aqueous electrolyte, a positive electrode that includes a positive active material capable of intercalation and deintercalation of lithium ions, and a negative electrode that includes a negative active material that includes a vanadium-based oxide represented by the equation:
LiₓM_{y}V_{z}O_{2+d}

where 0.1≦x≦2.5, 0≦y≦0.5, 0.5≦z≦1.5, 0≦d≦0.5 and M is selected from the group of Al, Cr, Mo, Ti, W and Zr.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a graph of free-energy peaks of a vanadium oxide.

FIG. 2 shows a graph of the Debye-Waller Factor for vanadium with various valence numbers.

FIG. 3 shows a schematic view of a lithium secondary battery according to an exemplary embodiment of the present invention.

FIG. 4 shows a graph of the charge-discharge characteristics of lithium secondary batteries that include the negative active materials of Example 1, Example 2, Example 3, and Comparative Example 1.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element such as a layer, film, region or substrate is referred to as being “on” another element, it can be directly on the other element or intervening elements may also be present. In contrast, when an element is referred to as being “directly on” another element, there are no intervening elements present.

An exemplary embodiment of the present invention provides a negative active material that includes a metal oxide active material that has a higher capacity than a conventional graphite active material. The negative active material is a vanadium-based oxide that has a free-edge energy peak between about 5350 eV to about 5530 eV, measured by Extended X-ray Absorption Fine Structure.

The negative active material may be represented by the following Formula 1:
LiₓM_{y}V_{z}O_{2+d} (1)

where 0.1≦x≦2.5, 0≦y≦0.5, 0.5≦z≦1.5, 0≦d≦0.5, and M is an element selected from the group including Al, Cr, Mo, Ti, W and Zr.

The negative active material has a ratio between crystalline axes a and c (c/a ratio) before intercalation of lithium that is between about 2.5 to about 6.5, preferably about 3.0 to about 6.2. When the c/a ratio falls outside this range, intercalation and deintercalation of lithium becomes structurally difficult, the potential of lithium intercalation and deintercalation increases to more than 0.6V, and a hysteris phenomenon occurs in which the potential difference between intercalation and deintercalation becomes larger as oxygen anions contribute to the reaction.

The negative active material has c/a ratio after intercalation of lithium ranging is from about 3.5 to about 7.0, preferably about 4.0 to about 7.0. The lattice change by intercalated lithium is negligible when the c/a ratio is less than 3.5. Conversely, it is difficult to maintain crystalline structure when the c/a ratio is larger than 7.0.

When the ratio between the crystalline axes a and c (c/a ratio) was measured using the Powder X-ray diffraction (Cu Kα-lay), Si having a high crystallinity was used as an internal reference to increase accuracy of the lattice constant, and the diffraction pattern was analyzed with the Rietveld analysis to increase confidence of the lactic phase.

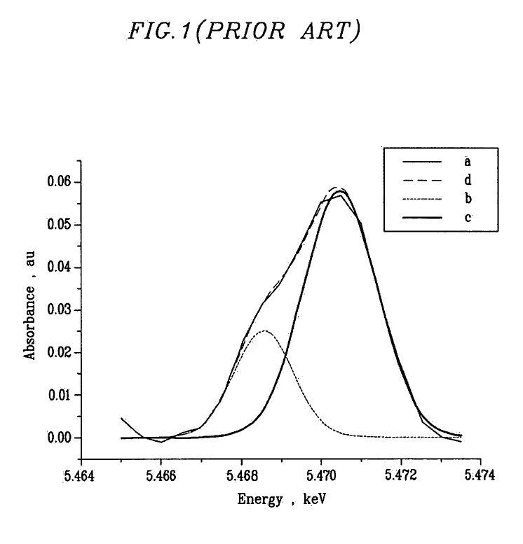

The free-edge energy peak of a conventional unsubstituted vanadium-based oxide has a relatively large area, as shown in FIG. 1. In FIG. 1, line a shows the actual measurement of free-edge energy, line b shows the first component of free-edge energy, line c shows the second component of free-edge energy absorbing higher energy than the first component, and line d is a line fitted similarly to the actual measurement values of lines b and c.

The area under the free-edge energy peak represents the area under the absorption peak caused by a 1s to 3d electron transition and also represents the sum of the first component of free-edge energy and the second component of free-edge energy peak areas. The first component of free-edge energy and the second component of free-edge energy peaks are fitted with a Gaussian distribution and the area of the free-edge energy peak is calculated.

The area of the free-edge energy peak of the negative active material ranges from about 3×10⁻⁵ to about 9×10⁻⁵, which is smaller than the free-edge energy peak of conventional unsubstituted vanadium-based oxide. This contributes to the high capacity and good life cycle of the negative active material.

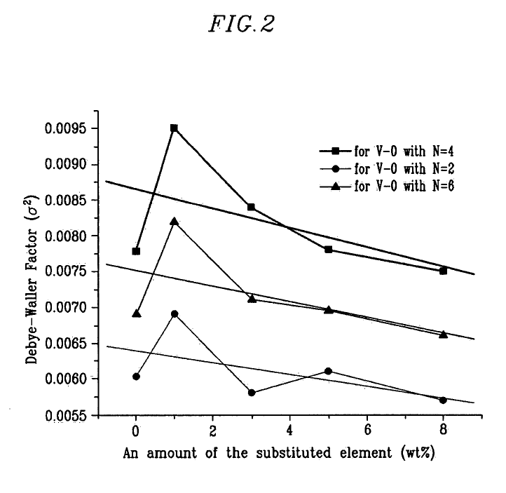

The stability of the crystalline lattice during thermal vibration is especially important because some of the vanadium in the vanadium-based oxide in the negative active material is substituted with another metal. The stability of the crystalline lattice during thermal vibration is evaluated by the Debye-Waller Factor. FIG. 2 shows that the Debye-Waller Factor decreases when the amount of a substituted metal increases. The Debye-Waller Factor becomes saturated as the amount of a substituted element is increased. However, a small amount of a substituted element may increase the stability of the crystalline lattice during thermal vibration but decrease the capacity of the negative active material. Therefore, the amount of the substituted element (M from Formula 1) to be added must balance the need for a stable crystalline lattice with the need for a high capacity material. The amount of the substituted element M to achieve proper balance between stability and capacity is about 1 to about 5 wt %, preferably about 1 to about 5 wt % based on the total weight of the negative active material. The structure stability decreases when the amount of the substituted element M is less than 1 wt %, and the capacity also decreases when the amount of the substituted element M is larger than 5 wt %.

The negative active material of the present invention has a smaller free-edge energy peak, less distribution of atomic distance, a smaller thermal vibration factor, and a smaller degree of lattice disorder than conventional unsubstituted vanadium-based oxide material, which gives the negative active material a high capacity and good cycle life.

The process of making the negative active material of the present invention will now be described. First, a vanadium-containing source, a lithium-containing source, and a metal-containing source are mixed in solid phase. The mixing ratio of the vanadium-containing source, the lithium-containing source, and the metal-containing source are regulated to be within the proper range.

The vanadium-containing source may be one or more of vanadium metal, VO, V₂O₃, V₂O₄, V₂O₅, V₄O₇, VOSO₄·nH₂O, NH₄VO₃, and the like.

The lithium-containing source may be one or more of lithium carbonate, lithium hydroxide, lithium nitrate, and lithium acetate.

The metal-containing source may be one or more of an oxide or a hydroxide, where the oxide or the hydroxide includes at least one of Al, Cr, Mo, Ti, W, and Zr. Examples of the metal-containing source include, but are not limited to, Al(OH)₃, Al₂O₃, Cr₂O₃, MoO₃, TiO₂, WO₃, or ZrO₂.

The mixture is heat-treated at a temperature of about 500° C. to about 1400° C., and more advantageously at about 900° C. to about 1200° C. under a reducing atmosphere. If the temperature is outside the range of about 500° C. to about 1400° C., an impurity phase, such as Li₃VO₄ or the like, may be formed. Impurities may reduce the cycle life and the capacity of a battery.

The reducing atmosphere may include nitrogen, argon, an N₂/H₂ mixed gas, a CO/CO₂ mixed gas, or helium. The partial pressure of oxygen in the reducing atmosphere may be under about 2×10⁻¹ atm. If the partial pressure of oxygen is about 2×10⁻¹ atm or greater, the reducing atmosphere is changed into an oxidization atmosphere in which a metal oxide may be oxidized. If the metal oxide is oxidized, it may be synthesized into other oxygen-rich phases or combined with oxygen and more than two other impurity phases.

A non-aqueous secondary battery according to an exemplary embodiment of the present invention includes the negative active material and also includes a positive electrode that includes positive active material capable of intercalating and deintercalating lithium ions. The positive active material may be, but is not limited to, at least one the formulas (2) to (13):
LiₓMn_{1-y}M_{y}A₂ (2)
LiₓMn_{1-y}M_{y}O_{2-z}X_{z} (3)
LiₓMn₂O_{4-z}X_{z} (4)
LiₓCo_{1-y}M_{y}A₂ (5)
LiₓCo_{1-y}M_{y}O_{2-z}X_{z} (6)
LiₓNi_{1-y}M_{y}A₂ (7)
LiₓNi_{1-y}M_{y}O_{2-z}X_{z} (8)
LiₓNi_{1-y}CO_{y}O_{2-z}X_{z} (9)
LiₓNi_{1-y-z}Co_{y}M_{z}A_{α} (10)
LiₓNi_{1-y-z}CO_{y}MₓO_{2-α}X_{α} (11)
LiₓNi_{1-y-z}Mn_{y}M_{z}A_{α} (12)
LiₓNi_{1-y-z}Mn_{y}M_{z}O_{2-α}X_{α} (13)

where 0.90≦x≦1.1, 0≦y≦0.5, 0≦z≦0.5, and 0≦α≦2, M is at least one of Al, Ni, Co, Mn, Cr, Fe, Mg, Sr, V, and rare earth elements, A is at least one of O, F, S, and P, and X is F, S, or P.

The negative and positive electrodes are fabricated by coating an active material compound on the current collector. The active material compound is prepared by mixing the active material, a conductive agent, a binder, and a solvent. This electrode fabrication method is well known in the related art and the detailed description is therefore omitted.

Any electronic conductive material may be used as the conductive agent unless it causes a chemical change. Conductive agents that may be used include, for example, natural graphite, artificial graphite, carbon black, acetylene black, ketjen black, carbon fiber, or metal powder or metal fiber including copper, nickel, aluminum, and silver. A conducting material such as a polyphenylene derivative disclosed in Japanese Laid Open Sho 59-20971 may be used with one or more of the conductive agents listed above.

The binder may be, but is not limited to, polyvinylalcohol, carboxymethyl cellulose, hydroxypropylene cellulose, diacetylene cellulose, polyvinyl chloride, polyvinyl pyrrolidone, polytetrafluoroethylene, polyvinylidenefluoride, polyethylene, or polypropylene.

The solvent may be, but is not limited to N-methylpyrrolidone.

An electrolyte in the non-aqueous electrolytic lithium secondary battery according to an exemplary embodiment of the present invention may include an organic solvent and a lithium salt. The electrolyte functions as a medium to allow the ions involved in the electrochemical reaction of the battery to move freely.

The organic solvent may be a material such as a carbonate, ester, ether, ketone, and the like. If the electrolyte is a carbonate, the carbonate may be at least one of dimethyl carbonate, diethylcarbonate, dipropylcarbonate, methylpropylcarbonate, ethylpropyl carbonate, methylethylcarbonate, ethylene carbonate, propylene carbonate, butylenes carbonate, and the like. If the electrolyte is an ester, the ester may be at least one of γ-butyrolactone, decanolide, valerolactone, mevalonolactone, caprolactone, n-methyl acetate, n-ethyl acetate, n-propyl acetate, and the like. If the electrolyte is an ether, the ether may be dibutyl ether or the like. The electrolyte may include an aromatic organic solvent, such as benzene, fluorobenzene, toluene, fluorotoluene, trifluorotoluene, xylene, and the like. The above examples are not intended to be limiting, and other organic solvents may be used. The organic solvents may be used alone or in combination with other organic solvents to form the electrolyte. The mixing ratio may be regulated according to the intended battery capacity.

The lithium salt may be one or more of LiPF₆, LiBF₄, LiSbF₆, LiAsF₆, LiCF₃SO₃, LiN(CF₃SO₂)₃, Li(CF₃SO₂)₂N, LiCF₉SO₃, LiClO₄, LiAlO₄, LiAlCl₄, LiNLiCl, LiI, and (CₘF₂ₘ₊₁SO₂)(CₙF₂ₙ₊₁SO₂) where m and n are natural numbers. The supporting salts are dissolved into the organic solvent where they serve as a source of lithium ions to promote the movement of lithium ions between positive and negative electrodes and to allow the battery to function. The concentration of lithium salt in the electrolyte may be about 0.1 M to about 2.0 M.

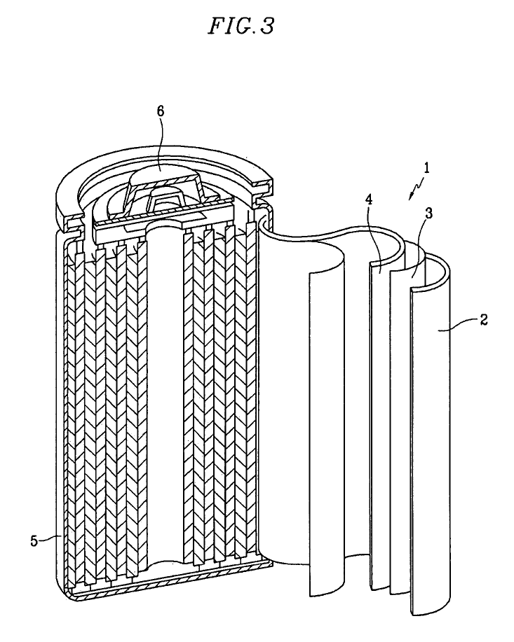

FIG. 3 shows an exemplary embodiment of a lithium secondary battery according is to the present invention. The secondary battery 1 comprises a negative electrode 2, a positive electrode 4, a separator 3 interposed between the electrodes 2 and 4, an electrolyte impregnated in the negative electrode 2 and the positive electrode 4, a container 5, and a sealing member 6 sealing the container 5. FIG. 3 illustrates a battery 1 of cylindrical shape, but the battery may be another type of battery including, for example, a prismatic battery or a pouch type battery.

The following examples further illustrate embodiments of the present invention. However, it is to be understood that the examples are for illustration purposes only, and that the invention is not limited to the examples.

### EXAMPLE 1

Li₂CO₃, V₂O₃ and TiO₂ were mixed in a Li:V:Ti mole ratio of 1.1:0.89:0.01 in solid phase. The mixture was heat-treated at a temperature of 1100° C. under a nitrogen atmosphere to prepare a negative active material, Li_{1.1}V_{0.89}Ti_{0.01}O₂. The prepared negative active material showed an R-3M crystalline structure in single-phase diffraction pattern.

80 wt % of the prepared negative active material, 10 wt % of a graphite conductive agent and 10 wt % of a polyvinylidene fluoride (PVDF) binder were mixed in N-methylpyrrolidone (NMP) to prepare a negative active material slurry. The slurry was coated on a copper current collector to fabricate a negative electrode. The density of active mass was 2.4 g/cc. The active mass is the mixture of active material, conductive agent, and binder formed on the current collector.

The negative electrode showed a high initial reversible capacity of 800 mAh/cc and good cycle life characteristics in a charge-discharge experiment.

### EXAMPLE 2

A negative active material and a negative electrode were prepared by the same method as in Example 1, except that the Li:V:Ti mole ratio was changed to 1.1:0.87:0.03 to prepare a negative active material, Li_{1.1}V_{0.87}Ti_{0.03}O₂.

### EXAMPLE 3

A negative active material and a negative electrode were prepared by the same method as in Example 1, except that the Li:V:Ti mole ratio was changed to 1.1:0.85:0.05 to prepare a negative active material, Li_{1.1}V_{0.85}Ti_{0.05}O₂.

### COMPARATIVE EXAMPLE 1

A negative active material and a negative electrode were prepared by the same method as in Example 1, except that Li₂CO₃ and V₂O₄ were mixed in a Li:V mole ratio of 1.1:0.9 in solid-phase to prepare a negative active material, Li _{1.1}V_{0.9}O₂.

### COMPARATIVE EXAMPLE 2

Li₂CO₃ and V₂O₄ were mixed in a Li:V mole ratio of 1.1:0.9 in solid-phase. The mixture was heat-treated at a temperature of 1300° C. under a nitrogen atmosphere to prepare a negative active material, Li_{1.1}V_{0.9}O₂. Using the prepared negative active material, a negative electrode was prepared by the same method as in Example 1.

Charge-Discharge Characteristics

Coin-type cells were made by arraying the negative electrodes of Example 1, Example 2, Example 3, Comparative Example 1, and Comparative Example 2 as working electrodes, arranging lithium with a circular shape of the same diameter as counter electrodes, inserting a separator made of a porous polypropylene film between the two electrodes, and using an electrolyte prepared by dissolving 1 mol/L LiPF₆ in a mixed solvent of propylenecarbonate (PC), diethylcarbonate (DEC), and ethylenecarbonate (EC) with a PC:DEC:EC ratio of 1:1:1.

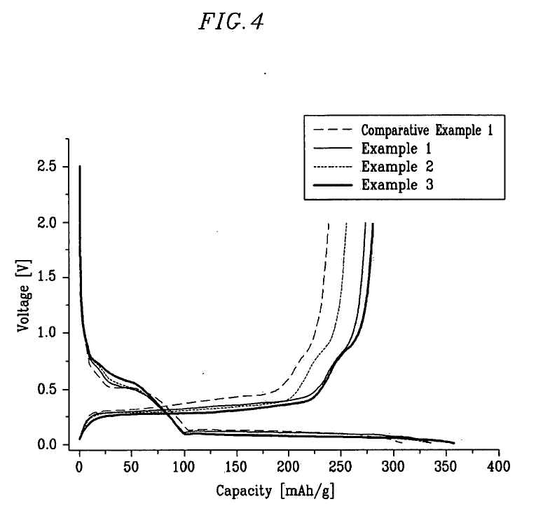

The charge-discharge characteristics of the coin-type cells were evaluated under a constant current condition of 0.2C at a voltage between 0 V to 2 V. The results are shown in FIG. 4. FIG. 4 shows that the negative active materials of Example 1, Example 2, and Example 3, which substitute Ti for some vanadium, have a higher capacity in charge-discharge experiments than the negative active material of Comparative Example 1, which excluded Ti.

Cycle life was evaluated by measuring percent capacity relative to initial capacity after 50 cycles of charging and discharging at 0.2 C. The results are shown in Table 1.

TABLE 1

| | Initial charge | | Initial | |
|---|---|---|---|---|
| | capacity | Initial discharge | efficiency | Cycle life |
| | [mAh/g] | capacity [mAh/g] | [%] | [%] |
| Example 1 | 336 | 274 | 82 | 86 |
| Example 2 | 333 | 256 | 77 | 78 |
| Example 3 | 358 | 280 | 78 | 75 |
| Comparative | 308 | 239 | 78 | 59 |
| Example 1 | | | | |
| Comparative | 288 | 214 | 74 | 36 |
| Example 2 | | | | |

As shown Table 1, the initial efficiencies of the negative active materials of Example 1, Example 2, and Example 3 are similar to those of Comparative Example 1 and Comparative Example 2, but the initial charge and discharge capacities and cycle life of Example 1, Example 2, and Example 3 are improved compared to those of Comparative Example 1 and Comparative Example 2.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A negative active material for use in a non-aqueous electrolyte secondary battery, comprising:
a vanadium-based oxide represented by the equation:
LiₓM_{y}V_{z}O_{2+d}
where 0.1≦x≦2.5, 0≦y≦0.5, 0.5≦z≦1.5, 0≦d≦0.5, and M is selected from the group of Al, Cr, Mo, Ti, W and Zr.

2. The negative active material of claim 1,
wherein the vanadium-based oxide has a free-edge energy peak of about 5350 eV to about 5530 eV when measuring Extended X-ray Absorption Fine Structure.

3. The negative active material of claim 1,
wherein the negative active material has a c/a ratio before intercalation of lithium of about 2.5 to about 6.5; and
wherein the negative active material has a c/a ratio after intercalation of lithium of about 3.5 to about 7.0.

4. The negative active material of claim 1,
wherein the area of the free-edge energy peak of the negative active material is about 3×10⁻⁵ to about 9×−5.

5. The negative active material of claim 1,
wherein M is included in the negative active material in an amount of about 1 to about 5 wt % based on the total weight of the negative active material.

6. A method of preparing a negative active material for use in a non-aqueous electrolyte secondary battery, comprising:
mixing a vanadium-containing source, a lithium-containing source, and a metal-containing source in solid phase; and
heating the mixture under a reducing atmosphere,
wherein the vanadium containing source, the lithium-containing source, and the metal-containing source are mixed in a ratio to produce a vanadium-based oxide represented by the equation:
LiₓM_{y}V_{z}O_{2+d}
where 0.1≦x≦2.5, 0≦y≦0.5, 0.5≦z≦1.5, 0≦d≦0.5, and M is selected from the group of Al, Cr, Mo, Ti, W and Zr.

7. The method of preparing a negative active material of claim 6,
wherein the vanadium-based oxide has a free-edge energy peak of about 5350 eV to about 5530 eV when measuring Extended X-ray Absorption Fine Structure.

8. The method of preparing a negative active material of claim 6,
wherein the vanadium-containing source includes at least one of vanadium metal, VO, V₂O₃, V₂O₄, V₂O₅, V₄O₇, VOSO₄·H₂O and NH₄VO₃.

9. The method of preparing a negative active material of claim 6,
wherein the lithium-containing source includes at least one of lithium carbonate, lithium hydroxide, lithium nitrate, and lithium acetate.

10. The method of preparing a negative active material of claim 6,
wherein the metal-containing source includes at least one of an oxide of at least one metal selected from the group of Al, Cr, Mo, Ti, W, and Zr, and a hydroxide of at least one metal selected from the group of Al, Cr, Mo, Ti, W, and Zr.

11. The method of preparing a negative active material of claim 6,
wherein the mixture is heated at a temperature of about 500° C. to about 1400° C.

12. The method of preparing a negative active material of claim 11,
wherein the mixture is heated at a temperature of about 900° C. to about 1200° C.

13. The method of preparing a negative active material of claim 6,
wherein the reducing atmosphere includes at least one of nitrogen, argon, an N₂/H₂ mixed gas, a CO/CO₂ mixed gas, or helium.

14. The method of preparing a negative active material of claim 6,
wherein the partial pressure of oxygen in the reducing atmosphere is less than 2×10⁻¹ atm.

15. A non-aqueous electrolyte lithium secondary battery, comprising:
a non-aqueous electrolyte;
a positive electrode that includes a positive active material capable of intercalation and deintercalation of lithium ions; and
a negative electrode that includes a negative active material that includes a vanadium-based oxide represented by the equation:
LiₓM_{y}V_{z}O_{2+d}
where 0.1≦x≦2.5, 0≦y≦0.5, 0.5≦z≦1.5, 0≦d≦0.5, and M is selected from the group of Al, Cr, Mo, Ti, W and Zr.

16. The non-aqueous electrolyte lithium secondary battery of claim 15,
wherein the vanadium-based oxide has a free-edge energy peak of about 5350 eV to about 5530 eV when measuring Extended X-ray Absorption Fine Structure.

17. The non-aqueous electrolyte lithium secondary battery of claim 15,
wherein the negative active material has a c/a ratio before intercalation of lithium of about 2.5 to about 6.5; and
wherein the negative active material has a c/a ratio after intercalation of lithium of about 3.5 to about 7.0.

18. The non-aqueous electrolyte lithium secondary battery of claim 15,
wherein the area of the free-edge energy peak of the negative active material is about 3×10⁻⁵ to about 9×10⁻⁵.

19. The non-aqueous electrolyte lithium secondary battery of claim 15,
wherein M is included in the negative active material in an amount of about 1 to about 5 wt % based on the total weight of the negative active material.

20. The non-aqueous electrolyte lithium secondary battery of claim 15,
wherein the negative electrode further includes a conductive agent and a binder.
